(19) United States
(12) Patent Application Publication
(10) Pub. No.: US 2013/0257704 A1
(43) Pub. Date: Oct. 3, 2013

(54) BACKLIGHT MODULE AND LIQUID CRYSTAL DISPLAY APPARATUS

(71) Applicants: Weiyan Wei, Shenzhen (CN); Jianfa Huang, Shenzhen (CN)

(72) Inventors: Weiyan Wei, Shenzhen (CN); Jianfa Huang, Shenzhen (CN)

(21) Appl. No.: 13/501,457

(22) PCT Filed: Mar. 27, 2012
(86) PCT No.: PCT/CN12/73105

§ 371 Date: Apr. 12, 2012

(51) Int. Cl. G09G 3/36; F21V 13/02; F21V 8/00

(52) U.S. Cl. 345/102; 362/613; 362/609

(57) ABSTRACT

The present invention provides a backlight module and a liquid crystal display apparatus. The backlight module comprises a light guide plate, an elongated base and elongated light sources. There is a predetermined angle between a longitudinal direction of each of the elongated light sources and a longitudinal direction of the elongated base, and projections of the elongated light sources in the longitudinal direction of the elongated base are connected or overlapped with each other. In the backlight module and the liquid crystal display apparatus of the present invention, the hot spot phenomena can be mitigated by altering the arrangement of the elongated light sources.

### FIELD OF THE INVENTION

The present invention relates to field of a liquid crystal display (LCD) technology, and more particularly to a backlight module and a liquid crystal display apparatus capable of mitigating hot spot phenomena.

### BACKGROUND OF THE INVENTION

Liquid crystal displays (LCDs) have been widely applied in electrical products. Currently, most of LCDs are backlight type LCDs, and comprise a liquid crystal display panel and a backlight module. According to the position of the light sources, the backlight module can be classified into a side-light type or a direct-light type for providing a backlight to the liquid crystal display panel.

Referring to FIG. 1 and FIG. 2, FIG. 1 is a structural diagram showing a conventional side-light type backlight module, and FIG. 2 is a schematic diagram showing a light source of the conventional side-light type backlight module. In FIG. 1 and FIG. 2, light rays of the light source of the conventional side-light type backlight module are guided by using a light guide plate 101. The light source of the backlight module is disposed at one side of the light guide plate 101. However, in general, light emitting diodes (LEDs) 103 are arranged on a printed circuit board 102 and distanced from each other by a pitch. Due to the distance between each two of the LEDs 103, a brightness of the light rays guided by the light guide plate 101 is uneven at a light-incident side thereof, resulting hot spot phenomena.

As a result, it is necessary to provide a backlight module and a liquid crystal display apparatus to solve the problems existing in the conventional technologies, as described above.

### SUMMARY OF THE INVENTION

The present invention provides a backlight module and a liquid crystal display apparatus to mitigate the hot spot phenomena by altering the arrangement of the elongated light sources, so as to solve the hot spot problem existing in the conventional technologies.

The present invention provides a backlight module which comprises: a light guide plate; an elongated base disposed at a light-incident side of the light guide plate; and a plurality of elongated light sources disposed on the elongated base, wherein there is a predetermined angle between a longitudinal direction of each of the elongated light sources and a longitudinal direction of the elongated base, and projections of the elongated light sources in the longitudinal direction of the elongated base are connected or overlapped with each other; wherein the predetermined angle is greater than 0 degree and less than 90 degrees, and a channel is formed between each adjacent two of the elongated light sources, and a width of the channel is greater than 0.6 mm.

In the backlight module of the present invention, the backlight module further comprises a reflective element configured to reflect the light rays emitted from the elongated light sources to a light-incident surface of the light guide plate, wherein the elongated light sources are disposed corresponding to a top side or a bottom side of the light-incident surface of the light guide plate.

The present invention provides a backlight module, and the backlight module comprises: a light guide plate; an elongated base disposed at a light-incident side of the light guide plate; and a plurality of elongated light sources disposed on the elongated base, wherein there is a predetermined angle between a longitudinal direction of each of the elongated light sources and a longitudinal direction of the elongated base, and projections of the elongated light sources in the longitudinal direction of the elongated base are connected or overlapped with each other.

In the backlight module of the present invention, the predetermined angle is greater than 0 degree and less than 90 degrees.

In the backlight module of the present invention, the predetermined angle is in the range of 60 degrees to 80 degrees.

In the backlight module of the present invention, the predetermined angle is in the range of 10 degrees to 30 degrees.

In the backlight module of the present invention, a channel is formed between each adjacent two of the elongated light sources, and a width of the channel is greater than 0.6 mm.

In the backlight module of the present invention, the backlight module further comprises a reflective element configured to reflect the light rays emitted from the elongated light sources to a light-incident surface of the light guide plate, wherein the elongated light sources are disposed corresponding to a top side or a bottom side of the light-incident surface of the light guide plate.

In the backlight module of the present invention, a surface of the elongated base for arranging the elongated light sources is vertical to the light-incident surface of the light guide plate.

In the backlight module of the present invention, the reflective element is a single-planar reflector, a multi-planar reflector or a curved reflector.

In the backlight module of the present invention, wherein the elongated light sources are elongated light emitting diodes, and the elongated base is a printed circuit board.

The present invention further provides a liquid crystal display (LCD) apparatus, and the liquid crystal display apparatus comprises a display panel and a backlight module. The backlight module comprises: a light guide plate; an elongated base disposed at a light-incident side of the light guide plate; and a plurality of elongated light sources disposed on the elongated base, wherein there is a predetermined angle between a longitudinal direction of each of the elongated light sources and a longitudinal direction of the elongated base, and projections of the elongated light sources in the longitudinal direction of the elongated base are connected or overlapped with each other.

In the LCD apparatus of the present invention, the predetermined angle is greater than 0 degree and less than 90 degrees.

In the LCD apparatus of the present invention, the predetermined angle is in the range of 60 degrees to 80 degrees.

In the LCD apparatus of the present invention, the predetermined angle is in the range of 10 degrees to 30 degrees.

In the LCD apparatus of the present invention, a channel is formed between each adjacent two of the elongated light sources, and a width of the channel is greater than 0.6 mm.

In the LCD apparatus of the present invention, the backlight module further comprises a reflective element configured to reflect the light rays emitted from the elongated light sources to a light-incident surface of the light guide plate, wherein the elongated light sources are disposed corresponding to a top side or a bottom side of the light-incident surface of the light guide plate.

In the LCD apparatus of the present invention, a surface of the elongated base for arranging the elongated light sources is vertical to the light-incident surface of the light guide plate.

In the LCD apparatus of the present invention, the reflective element is a single-planar reflector, a multi-planar reflector or a curved reflector.

In the LCD apparatus of the present invention, wherein the elongated light sources are elongated light emitting diodes, and the elongated base is a printed circuit board.

With the use of the backlight module and the liquid crystal display apparatus of the present invention, the hot spot phenomena can be mitigated by altering the arrangement of the elongated light sources, so as to solve the hot spot problem existing in the conventional technologies.

The structure and the technical means adopted by the present invention to achieve the above and other objects can be best understood by referring to the following detailed description of the preferred embodiments and the accompanying drawings:

### DESCRIPTION OF THE DRAWINGS

FIG. 1 is a structural diagram showing a conventional side-light type backlight module;

FIG. 2 is a schematic diagram showing a light source of the conventional side-light type backlight module;

FIG. 3 is a structural diagram showing a backlight module according to a first preferred embodiment of the present invention;

FIG. 4 is a schematic diagram showing the elongated light sources of the backlight module according to the first preferred embodiment of the present invention;

FIG. 5 is a schematic diagram showing the elongated light sources of the backlight module according to a second preferred embodiment of the present invention; and

FIG. 6 is a structural diagram showing a backlight module according to a second preferred embodiment of the present invention.

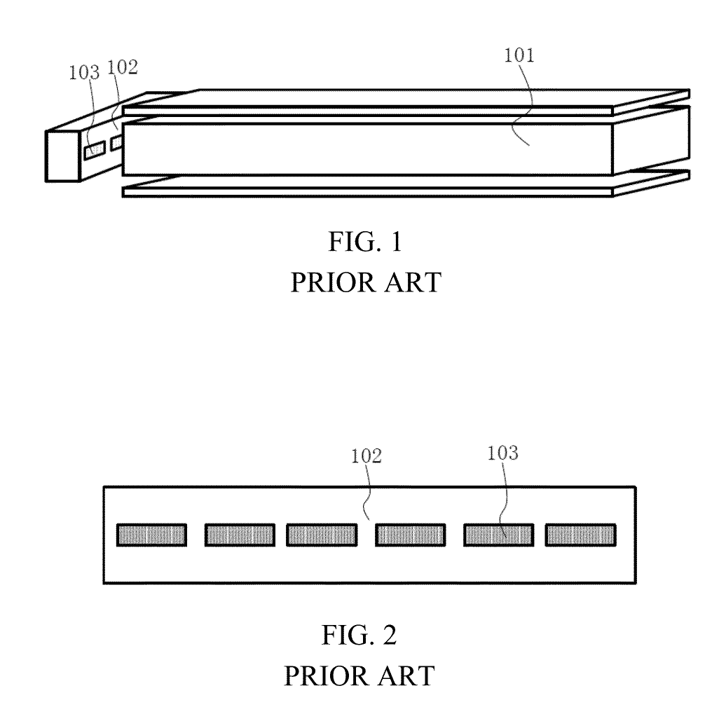

### DETAILED DESCRIPTION OF THE PREFERRED EMBODIMENTS

The following embodiments are exemplified by referring to the accompanying drawings, for describing specific embodiments implemented by the present invention. Furthermore, directional terms described by the present invention, such as upper, lower, front, back, left, right, inner, outer, side and etc., are only directions by referring to the accompanying drawings, and thus the used directional terms are used to describe and understand the present invention, but the present invention is not limited thereto.

In the drawings, like reference numerals indicate like components or items.

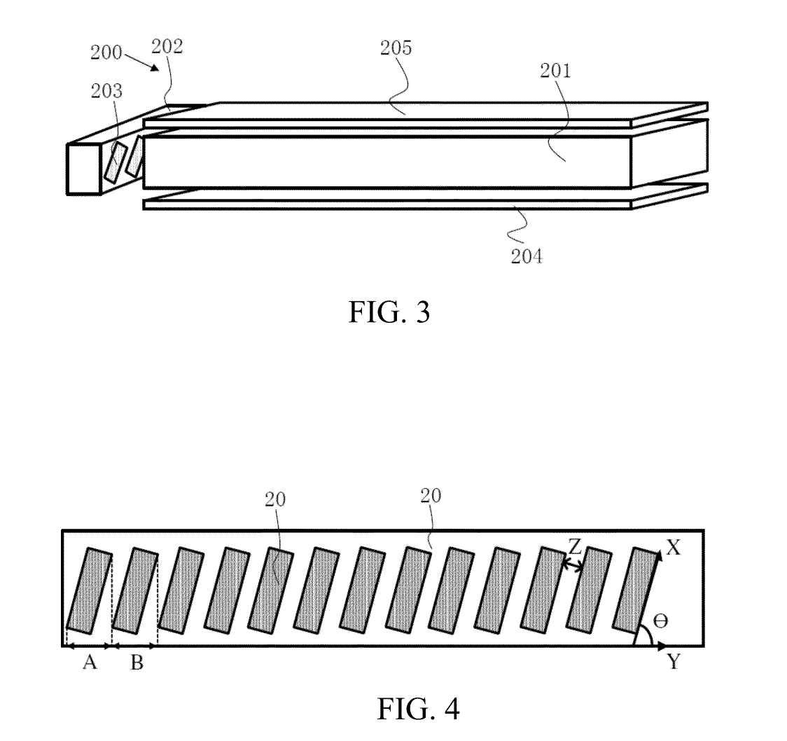

Referring to FIG. 3, FIG. 3 is a structural diagram showing a backlight module according to a first preferred embodiment of the present invention. In this embodiment, the backlight module 200 of the present invention may be a side-light type backlight module. The backlight module 200 comprises a light guide plate 201, an elongated base 202, a plurality of elongated light sources 203, a reflective film 204 and optical films 205. The elongated base 202 can be disposed at a light-incident side of the light guide plate 201. The elongated light sources 203 are disposed on the elongated base 202 for emitting light rays to the light guide plate 201, so as to allow the light guide plate 201 to guide the light rays. The reflective film 204 is disposed at the bottom of the light guide plate 201 for reflecting the light rays from the light guide plate 201. The optical films 205 are disposed on a light-emitting surface of the light guide plate 201 for improving an optical effect of the light rays outputted from the light guide plate 201. In this embodiment, there is a predetermined angle between a longitudinal direction of each of the elongated light sources 203 and a longitudinal direction of the elongated base 202, and projections of the elongated light sources 203 in the longitudinal direction of the elongated base 202 are connected or overlapped with each other.

When utilizing the backlight module 200 of the present embodiment, the elongated light sources 203 are obliquely arranged on the elongated base 202 at a specific angle (the predetermined angle) between the longitudinal direction of the elongated light sources 203 and the longitudinal direction of the elongated base 202, wherein the predetermined angle θ is greater than 0 degree and less than 90 degrees, for example less than or equal to 75 degrees. At the same time, the projections of the elongated light sources 203 in the longitudinal direction of the elongated base 202 are connected or overlapped with each other, thereby eliminating intervals between the elongated light sources 203 in a horizontal direction (i.e. the longitudinal direction of the elongated base 202). Therefore, the elongated light sources 203 can emit the light rays from anywhere along the longitudinal direction of the elongated base 202 for reducing the unevenness of the light rays on the light-incident surface of the light guide plate 201, as well as mitigating the hot spot phenomena of the backlight module 200. In this embodiment, a surface of the elongated base 202 for arranging the elongated light sources 203 is substantially parallel to the light-incident surface of the light guide plate 201.

The elongated light sources 203 of the backlight module 200 of the present embodiment can be arranged in various ways. For example, referring to FIG. 4, FIG. 4 is a schematic diagram showing the elongated light sources of the backlight module according to the first preferred embodiment of the present invention. As shown in FIG. 4, a line A indicates a projection of one of the elongated light sources 203 in the longitudinal direction of the elongated base 202, and a line B indicates a projection of another one of the elongated light sources 203 in the longitudinal direction of the elongated base 202, wherein the line A and the line B are connected to each other. That is, the elongated light sources 203 can emit the light rays from anywhere along the longitudinal direction of the elongated base 202. At the same time, the predetermined angle θ between the longitudinal direction of the elongated light sources 203 (the direction X in FIG. 4) and the longitudinal direction (the direction Y in FIG. 4) of the elongated base 202 can be greater, such as in the range of 60 degrees to 80 degrees. With the use of the increased predetermined angle θ, an amount of the elongated light sources 203 arranged on the elongated base 202 can be increased for raising a brightness of the backlight module 200.

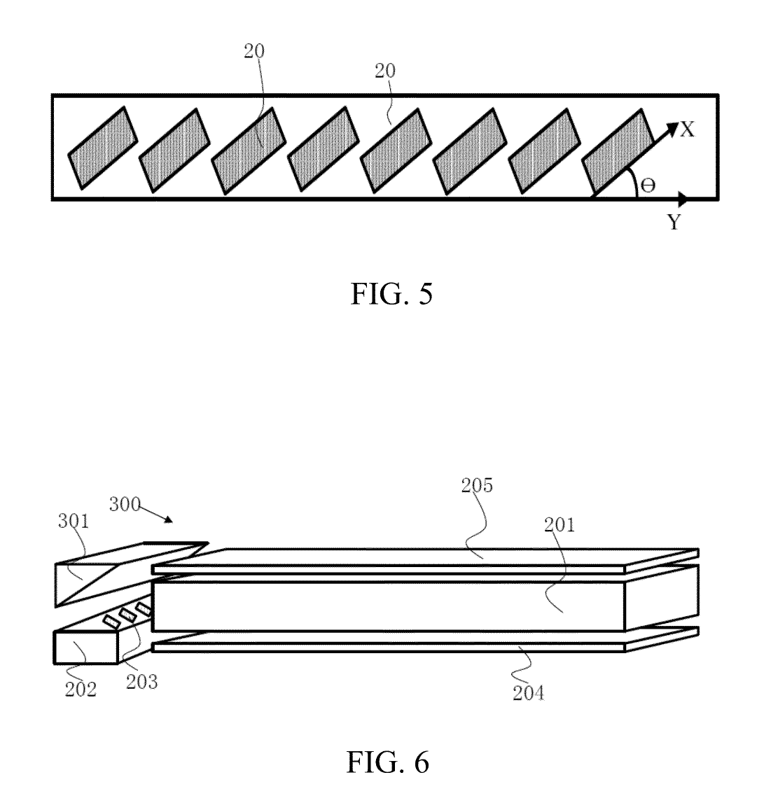

Furthermore, referring to FIG. 5, FIG. 5 is a schematic diagram showing the elongated light sources of the backlight module according to a second preferred embodiment of the present invention. The projections of the elongated light sources 203 in the longitudinal direction of the elongated base 202 are connected or overlapped (not shown) with each other. At the same time, the predetermined angle θ between the longitudinal direction of the elongated light sources 203 (the direction X in FIG. 5) and the longitudinal direction (the direction Y in FIG. 5) of the elongated base 202 can be less, such as in the range of 10 degrees to 30 degrees. In this case, amount of the elongated light sources 203 arranged on the elongated base 202 can be reduced for reducing a cost of the backlight module 200. Moreover, when using the small angleθ in the backlight module 20, the hot spot phenomena can be mitigated, and a thickness of the light guide plate 201 can be reduced.

The predetermined angle can be determined according to a length of the elongated light sources 203 and the thickness of the light guide plate 201. When the length of the elongated light sources 203 is constant, the predetermined angle can be enlarged according to an increased thickness of the light guide plate 201. In contrast, when the thickness of the light guide plate 201 is constant, the predetermined angle can be enlarged according to a reduced length of the elongated light sources 203. A channel (or a space) is formed between each adjacent two of the elongated light sources 203 as shown in FIG. 4, and a width Z of the channel can be greater than 0.6 mm, so as to ensure an electrical reliability and a convenience for arrangement.

Referring to FIG. 6, FIG. 6 is a structural diagram showing a backlight module according to a second preferred embodiment of the present invention. Only the difference between the third embodiment and the first embodiment will be described hereinafter, and thus the similar portions there-between will be not stated in detail herein. Compared with the first embodiment, the backlight module 300 of the second embodiment further comprises a reflective element 301. At this time, the surface of the elongated base 202 for arranging the elongated light sources 203 is substantially vertical to the light-incident surface of the light guide plate 201. The light rays are not directly emitted from the elongated light sources 203 to the light guide plate 201, but reflected to the light-incident surface of the light guide plate 201 by the reflective element 301. The elongated light sources 203 can be disposed corresponding to a top side or a bottom side of the light-incident surface of the light guide plate 201. In this case, the reflective element 301 may be a single-planar reflector, a multi-planar reflector or a curved reflector. In this embodiment, the reflective element 301 may be a wedge-shaped reflector.

When utilizing the backlight module 300 of the present embodiment, the elongated light sources 203 are obliquely arranged on the elongated base 202 at a specific angle between the longitudinal direction of the elongated light sources 203 and the longitudinal direction of the elongated base 202, and the projections of the elongated light sources 203 in the longitudinal direction of the elongated base 202 are connected or overlapped with each other. Therefore, the elongated light sources 203 can emit the light rays from anywhere along the longitudinal direction of the elongated base 202, and the light rays can be more uniformly reflected to the light-incident surface of the light guide plate 201 by the reflective element 301, thereby mitigating the hot spot phenomena of the backlight module 300. In addition, the elongated base 202 for arranging the elongated light sources 203 can be positioned to the top side or the bottom side of the light-incident surface of the light guide plate 201, thereby reducing a thickness of the backlight module 300.

The elongated light sources 203 of the present invention are, for example, cold cathode fluorescent lamps (CCFL), light emitting diodes (LED), organic light emitting diodes (OLED), electro-luminescence (EL) devices, light bars or any combination thereof. Preferably, the elongated light sources 203 are elongated LEDs, and the elongated base 202 is a printed circuit board (PCB).

The reflective film 204 of the present invention may be a reflective sheet or a reflective coated layer which may be made of a highly reflective material for reflecting the light rays incident on a light reflection surface of the light guide plate 201. The highly reflective material may be Ag, Al, Au, Cr, Cu, In, Ir, Ni, Pt, Re, Rh, Sn, Ta, W, Mn, alloy of any combination thereof, white reflective paint with etiolation-resistant and heat-resistant properties or any combination thereof for reflecting light. It is worth mentioning that the highly reflective material can be coated on the light reflection surface of the light guide plate 201 for replacing or omitting the reflective film 204.

The optical films 150 of the present invention may comprise a diffuser, a prism sheet, a turning prism sheet, a brightness enhancement film (BEF), a dual brightness enhancement film (DBEF), a diffused reflective polarizer film (DRPF) or any combination thereof, and are disposed on the light output surface of the light guide plate for improving the optical effect of the light rays outputted from the light guide plate 201.

The present invention further provides a liquid crystal display apparatus which comprises a display panel and the backlight module. The backlight module comprises a light guide plate; an elongated base disposed at a light-incident side of the light guide plate; and a plurality of elongated light sources disposed on the elongated base, wherein there is a predetermined angle between a longitudinal direction of each of the elongated light sources and a longitudinal direction of the elongated base, and projections of the elongated light sources in the longitudinal direction of the elongated base are connected or overlapped with each other. The principle and beneficial effect of the liquid crystal display apparatus are the same or similar to the description in the above-mention embodiments of the backlight module. Please refer to the above-mention embodiments of the backlight module.

As described above, in the backlight module and the liquid crystal display apparatus of the present invention, the hot spot phenomena can be mitigated by altering the arrangement of the elongated light sources. Moreover, the predetermined angle can be determined according to user's requirements, so as to achieve a better display effect, and solve the problem of the hot spot phenomena.

The present invention has been described with a preferred embodiment thereof and it is understood that many changes and modifications to the described embodiment can be carried out without departing from the scope and the spirit of the invention that is intended to be limited only by the appended claims.

1. A backlight module, comprising:
a light guide plate;
an elongated base disposed at a light-incident side of the light guide plate; and
a plurality of elongated light sources disposed on the elongated base, wherein there is a predetermined angle between a longitudinal direction of each of the elongated light sources and a longitudinal direction of the elongated base, and projections of the elongated light sources in the longitudinal direction of the elongated base are connected or overlapped with each other;
wherein the predetermined angle is greater than 0 degree and less than 90 degrees, and a channel is formed between each adjacent two of the elongated light sources, and a width of the channel is greater than 0.6 mm.

2. The backlight module according to claim 1, further comprising a reflective element configured to reflect the light rays emitted from the elongated light sources to a light-incident surface of the light guide plate, wherein the elongated light sources are disposed corresponding to a top side or a bottom side of the light-incident surface of the light guide plate.

3. A backlight module, comprising:
a light guide plate;
an elongated base disposed at a light-incident side of the light guide plate; and
a plurality of elongated light sources disposed on the elongated base, wherein there is a predetermined angle between a longitudinal direction of each of the elongated light sources and a longitudinal direction of the elongated base, and projections of the elongated light sources in the longitudinal direction of the elongated base are connected or overlapped with each other.

4. The backlight module according to claim 3, wherein the predetermined angle is greater than 0 degree and less than 90 degrees.

5. The backlight module according to claim 4, wherein the predetermined angle is in the range of 60 degrees to 80 degrees.

6. The backlight module according to claim 4, wherein the predetermined angle is in the range of 10 degrees to 30 degrees.

7. The backlight module according to claim 3, wherein a channel is formed between each adjacent two of the elongated light sources, and a width of the channel is greater than 0.6 mm.

8. The backlight module according to claim 3, further comprising a reflective element configured to reflect the light rays emitted from the elongated light sources to a light-incident surface of the light guide plate, wherein the elongated light sources are disposed corresponding to a top side or a bottom side of the light-incident surface of the light guide plate.

9. The backlight module according to claim 8, wherein a surface of the elongated base for arranging the elongated light sources is vertical to the light-incident surface of the light guide plate.

10. The backlight module according to claim 8, wherein the reflective element is a single-planar reflector, a multi-planar reflector or a curved reflector.

11. The backlight module according to claim 3, wherein the elongated light sources are elongated light emitting diodes, and the elongated base is a printed circuit board.

12. A liquid crystal display apparatus, comprising:
a display panel; and
a backlight module comprising:
a light guide plate;
an elongated base disposed at a light-incident side of the light guide plate; and
a plurality of elongated light sources disposed on the elongated base, wherein there is a predetermined angle between a longitudinal direction of each of the elongated light sources and a longitudinal direction of the elongated base, and projections of the elongated light sources in the longitudinal direction of the elongated base are connected or overlapped with each other.

13. The liquid crystal display apparatus according to claim 12, wherein the predetermined angle is greater than 0 degree and less than 90 degrees.

14. The liquid crystal display apparatus according to claim 13, wherein the predetermined angle is in the range of 60 degrees to 80 degrees.

15. The liquid crystal display apparatus according to claim 13, wherein the predetermined angle is in the range of 10 degrees to 30 degrees.

16. The liquid crystal display apparatus according to claim 12, wherein a channel is formed between each adjacent two of the elongated light sources, and a width of the channel is greater than 0.6 mm.

17. The liquid crystal display apparatus according to claim 12, further comprising a reflective element configured to reflect the light rays emitted from the elongated light sources to a light-incident surface of the light guide plate, wherein the elongated light sources are disposed corresponding to a top side or a bottom side of the light-incident surface of the light guide plate.

18. The liquid crystal display apparatus according to claim 17, wherein a surface of the elongated base for arranging the elongated light sources is vertical to the light-incident surface of the light guide plate.

19. The liquid crystal display apparatus according to claim 17, wherein the reflective element is a single-planar reflector, a multi-planar reflector or a curved reflector.

20. The liquid crystal display apparatus according to claim 12, wherein the elongated light sources are elongated light emitting diodes, and the elongated base is a printed circuit board.
